(19) United States
(12) Patent Application Publication
(10) Pub. No.: US 2009/0075818 A1
(43) Pub. Date: Mar. 19, 2009

(54) Nanosilver for preservation and treatment of diseases in agriculture field.

(76) Inventor: Jafar Rahman Nia, Tehran (IR)

Correspondence Address: BARRY CHOOBIN, 193 SUITE #18, TALEGHANI, BAHARE SHOMALI, TEHRAN, 1563714311, IR

(21) Appl. No.: 11/857,455

(22) Filed: Sep. 19, 2007

(51) Int. Cl. A01N 59/16; A01P 15/00

(52) U.S. Cl. 504/100; 424/618

(57) ABSTRACT

A nano silver active material disclosed for use in agriculture. The active material prevents and treats major diseases in agricultural field.

### FIELD OF THE INVENTION

The present invention relates, in general, to colloidal nono-silver, and, more particularly, to substances and methods to preserve and treat disease in agriculture field.

### BACKGROUND OF THE INVENTION

Pests, weeds, insects, molds, bacteria and other damaging agents adversely impact the health and growth of agricultural products. Significant effort has been made to develop organic chemicals that selectively stop, reduce, or prevent the damage caused by such damaging agents to agriculture. However, chemicals also have a tendency to enter into ecosystems and cause undesirable ecological and environmental effects. Technologies are desired that can reduce the use of organic chemicals while ensuring that the damaging effects of pests, weeds, and other agents are checked or prevented. Another limitation of current technology based on the use of organic chemicals is the ineffective use of dosage. Often, the concentration of the dosage when it is first applied is very high which then rapidly decreases. Such an application provides more than a desired concentration immediately after application and then too low of the desired concentration after several days of the application. It is preferred in many cases that a more uniform and continuous protection from pests, weeds, etc. be available. Current technologies are unable to offer this.

### SUMMARY OF THE INVENTION

In one embodiment, it is an object of the present invention to provide a simple preparation method for silver nano particles having a well-controlled size in a surfactant solution. The nano silver colloid is prepared by the following steps—(1) dissolving silver nitrate crystal in distilled water; (2) adding surfactant, LABS (Linear alkyl benzene sulfonate) to the solution and; (3) adding reducing agent to the solution.

Additionally, the present invention provides methods of using the nano silver colloid for preservation and treatment of diseases in the agriculture field.

In the preferred embodiment, the present invention describes the processes and products for preservation and treatment of diseases in the agriculture field. The invention describes nano-silver active material enabled technologies for enhancing the quality of agriculture, increasing shelf life and quality of agricultural products, preservation and treatment of diseases that come with microorganism in the agricultural filed, killing existing microorganisms on seeds or killing pathogens using seeds for living, disinfecting soil and green houses, and growing and increasing root and leaves in their numbers and sizes.

### BRIEF DESCRIPTION OF THE DRAWINGS

The invention, as well as its many advantages, maybe further understood by the following detailed description and drawing in which:

FIG. 1 shows UV absorbance of silver particle prepared in presence of different surfactants.

FIG. 2(A) to 2(C) shows particle size distributions of silver particle prepare in different surfactants.

FIG. 2 (A) shows LABS, which is an anionic surfactant.

FIG. 2 (B) shows SDS, which is an anionic surfactant.

FIG. 2 (C) shows Tween 20, which is a nonionic surfactant.

### DETAILED DESCRIPTION OF THE PREFERRED EMBODIMENT

In one embodiment, the present invention provides a process for preparing metal nano particles by using anionic and nonionic surfactant and suitable metal salt and a reducing agent, the metal salt can be effectively reduced into metal nano particles having a uniform particle size. Suitable surfactant useful in the process according to the invention are LABS (linear alkyl benzene sulfonate), tween 20 (polysorbate 20). Tween 60 (polysorbate 60), Tween 80 (polysorbate 80), SDS (sodium dodecyl sulfate). That the best result was for LABS. Generally, the amount or concentration of the surfactant used in the invention can be, but is not limited to 0.05-20 wt. % preferably; the amount is 2-5 wt %.

Suitable reducing agents useful in the process according to the invention are hydrazine, NaBH⁴, LiBH⁴, Glucose. The best result was for hydrazine. Generally, the amount or concentration of the hydrazine used in the invention can be, but is not limited to 1×10-5-10 g. preferably, the amount is 3×10⁻⁴−5×10⁻³ g.

This nano silver colloid is prepared at room temperature and reaction time is 1 hour, and it is possible to synthesis this colloid in shorter time.

The process for preparing metal nano particles according to the invention exhibits several following advantages:

Controlling the size of nano particles by a simple method.

Easy to use and no need for particular specialty.

Wide application.

Minimum side effects on body.

It is a strong insecticide against microbes.

Stable compounds.

The smallest particles (nano).

Short time for synthesis.

Using aqueous solvent instead of organic solvent.

The process of the invention is described herein below with reference to the following examples, which are illustrative and should not be construed as limiting the scope of the invention.

### Example 1

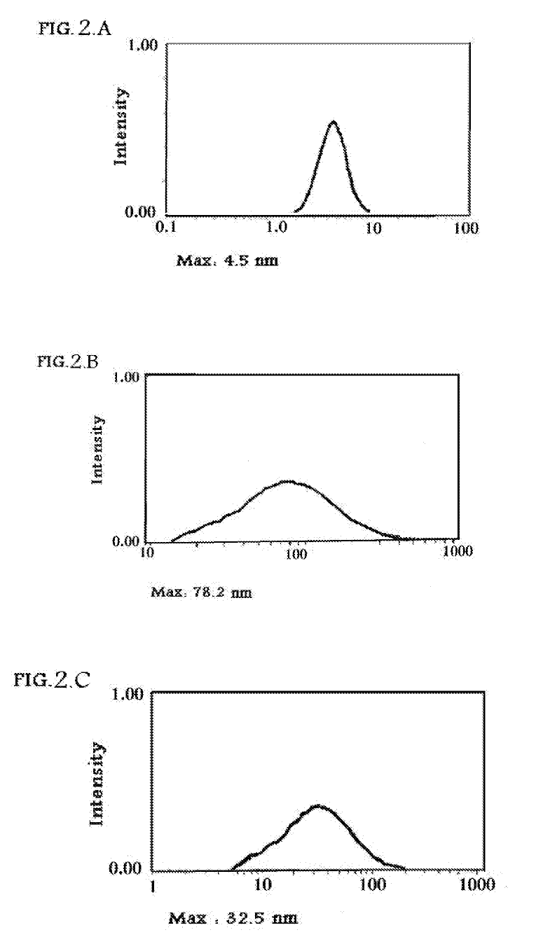

The 4.5 g LABS (Linear alkyl benzene sulfonate) was dissolved in 95 ml distilled water and then was added into a solution containing 0.32 g of silver nitrate. After mixing thoroughly, 0.2 g of hydrazine solution (0.03 M) was added in to the solution, a yellowish silver colloidal solution was formed. The UV-Vis spectrum of the reaction solution revealed an absorption bond at about 415 nm that is the characteristic absorption bond of the nano silver particle. Dynamic light scattering result of the reaction solution, as shown in FIG. 2 (A), show the average particle size is 4.5 nm.

### Example 2

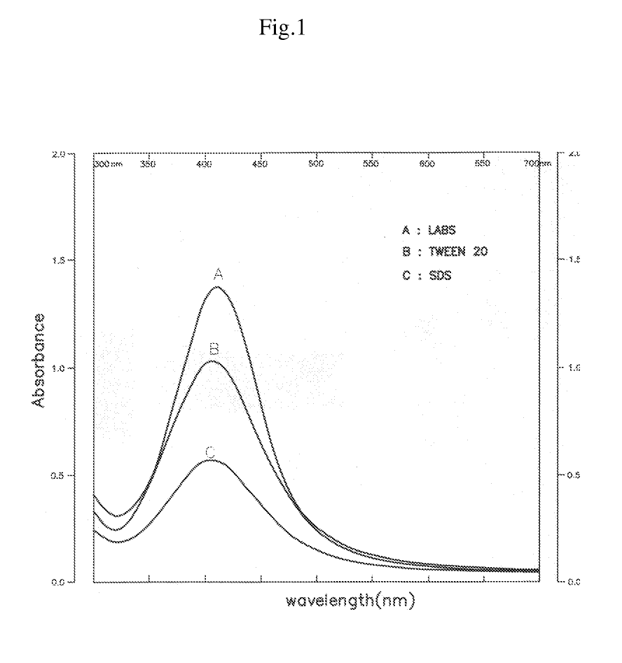

The same procedure as in example 1 was repeated except the 4.5 g LABS was replaced with 4.5 g SDS (sodium dodecyle sulfate). The UV spectra of the obtained nano silver colloidal solution in FIG. 1, and the average particle size were 78.2 nm, as show in FIG. 2 (B).

### Example 3

Tween 20 (polysorbate 20) was used in place of LABS in example 1. The UV-spectra of the obtained nano silver colloidal solution in FIG. 1 and the average particle size was 32.5 nm, as shown in FIG. 2 (C).

### Example 4

The colloidal nano silver prepared in example 1-3 was examined to determine the antimicrobial activity of the colloid.

Providing sterile culture medium of NA and purr plate of it.

Providing microbial suspension of E-coli bacteria standard soosh

(ATCC25 922)

to McFarland method that it is concentration is 158 cfu/ml.

Providing a microbial suspension with concentration of 105 from above suspension.

Mixing ⅓ nanosilver colloid and ⅔ of provided bacteria.

Culturing of mixing material in previous step on NA culture medium.

Putting the plates in the Incubator in 25oC for 24 hours.

After 24 hours, one loop is taken from those plates, and, put on new medium of NA.

After 24 hours being in Incubator, these plates are checked for colony count of bacteria.

### Example 5

The disclosed solution was used for controlling septoria leaf blotch, yellow rust, fusarium, and powdery mildew on wheat which showed that nanosilver controls wheat disease. With low dosage of nanosilver, the nano silver active material controlled schlorotenia on canola or rapeseed and sphaerotheca foliginea in the cucumber and rape seed and rose flower, and in orchard peach leaf curl.

After harvesting for having more shelf life we used nanosilver for preventing and controlling any microorganism that makes problem and can damage our productions. The solution was tested on various agriculture products like citrus, lime, wheat, barley and the solution was able to prevent their damages. Furthermore, the nano silver active material was used for packaging the agricultural products. The results were as following: control damages in the package and more shelf life in comparison with control.

The experiment demonstrated that the present invention improves stimulation of growing in all of the cases. In treating seeds with the nano-silver active material, the seeds grow with high speed and have longer root. The active material was sprayed on plants, resulting in changing the size of the leaves and causing the leaves to become fresher.

### Example 6

A solution was made in some dosages with nano silver, and then the seeds were treated for testing their germination. In the case of wheat, the following were as control, 0 ppm, 20 ppm, 40 ppm, 60 ppm, 80 ppm with nano silver and treat the seeds (plant them in the sand in the standard situation, after one week the following results were obtained: the seeds grown in 0 ppm, 70%; in 20 ppm we had 78 out of 100, in 40 ppm % 90, in 60 ppm % 96 and in 80 ppm % 90 germination. In this example, speed of the growing was monitoring after 48 hours no growing was observed in the 20 ppm % 12, in the 40 ppm % 26, in 60 ppm % 18 and in 80 ppm % 4. This test showed that with the active material of present invention not only there was an increase in percentage of growing but also there was acceleration in the seeds growing.

### Example 7

The test was performed on wheat in the farm. The results were same as above and furthermore, seeds growing were improved.

### Example 8

The test was performed on rape seeds with the same results as above. That is, in 0 ppm or control there was % 69 germination, in the 20 ppm germination was % 77, in 40 ppm germination was % 86 and in 60 ppm germination was % 78 of germination. These tests were repeated on the corn and cotton and a lot of other seeds, and the same results were obtained.

The above tests were performed on olive trees scions by dipping the scions in nano silver solution and planting them in the sand which was located inside the green house, growing stimulation of the roots occurred in the olive scion, also nano silver solution preserved the scion against disease in the mist.

By spraying the solution on the strawberry for preserving farm, the strawberry never afflicted to diseases and in comparison with control, as a result bigger fruit and bigger leaves were obtained and the diseases were treated.

The tests further were performed on wheat farm that involved a lot of diseases like Erysiphe graminis, septoria and fusarium. A comparison was made between the present invention solution and other method. On some fungicides after calculating the distribution of the disease on the leaves after 10 days, after 20 and 30 days, the nono-silver active material was ranked first.

The test was performed on erwinia amilovora on the apple trees, which is a bacteria that makes witches brome disease. Not only, this disease was controlled but also bigger and shinier leaves in comparison with the control were obtained.

The test was performed for planting corn and rice in the same manner as was performed on wheat and as result the toxicity was omitted.

The solution was tested on the oranges fruit. When, oranges were dipped in the solution the shelf life of the fruit were increased for longer period, for example: with 10 ppm about 2 weeds more than control and with 50 ppm of our nano silver solution more than 2 months in comparison with control.

For Nano silver packaging, the Nano-silver active material was mixed with polymers, as result, packaging had longer shelf life.

The tested was performed on packaging even on dairy and meat and fruit and dry goods, same results were obtained.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed:

1. A nano-silver active martial for agricultural products, said nano-silver active material comprising:
Colloidal silver, silver powders, silver composites, silver compounds, and silver salt wherein said silver salt comprises silver nitrate and silver chloride.

2. The nano-silver active material as claimed in claim 1, wherein said active nano-silver material has a diameter ranging between 1 to 250 nanometer, and wherein said active material kills micro-organisms and pathogens.

3. The nano-silver active material as claimed in claim 1, wherein said active material covers seeds and prevents pathogens to attack the seeds, thereby improving growth of said seeds.

4. The nano-silver active material as claimed in claim 1, wherein said active material increases shelf life of said seeds during storage and transportation of said seeds.

5. The nano-silver active material as claimed in claim 1, wherein said active material being applied to soil of farm and green houses bed, wherein said green houses bed comprises of: hydroponic and/or Iroponic system.

6. The nano-silver active material as claimed in claim 1, wherein said active material being applied to onions flower, onions, scions, cutting, and seeds, thereby disinfecting said onions, seeds and scions against diseases in the soil and green house bed, and killing any pathogens on/in of said onions, seeds and scions.

7. The nano-silver active material as claimed in claim 1, wherein said active material stimulates growing of root and leaves, and increases size and numbers of said root and leaves.

8. The nano-silver active material as claimed in claim 6, wherein said active material increases speed of growing root in said scions, onions and seeds.

9. The nano-silver active material as claimed in claim 1, wherein said active material increases light absorption, thereby increasing photosynthesis.

10. The nano-silver active material as claimed in claim 1, wherein said active material being applied to package agricultural products, thereby increasing shelf life of said product.

11. The nano-silver active material as claimed in claim 1, wherein said active material being applied on cut flowers and agricultural products after cutting and harvesting, in farms, in orchard and in green house in form of spray or dipping, thereby increasing shelf life and improving quality of said cut flowers and said agricultural products.

12. The nano-silver active material as claimed in claim 1, wherein said active material being applied during preservation, via spraying directly on the plant, irrigation or injecting into the trees and plants, thereby preventing and treating diseases in farm, orchard and greenhouses.
